(19) United States
(12) Patent Application Publication
(10) Pub. No.: US 2008/0199675 A1
(43) Pub. Date: Aug. 21, 2008

(54) LAMINATE FILM

(75) Inventors: Koji Koyama, Niihama-shi (JP); Tomohiro Maekawa, Niihama-shi (JP); Shinsuke Ochiai, Niihama-shi (JP)

Correspondence Address: SUGHRUE MION, PLLC, 2100 PENNSYLVANIA AVENUE, N.W., SUITE 800, WASHINGTON, DC, 20037, US

(73) Assignee: SUMITOMO CHEMICAL COMPANY, LIMITED, Tokyo (JP)

(21) Appl. No.: 12/021,360

(22) Filed: Jan. 29, 2008

(30) Foreign Application Priority Data
Jan. 31, 2007 (JP) 2007-021187
Jan. 31, 2007 (JP) 2007-021188

(51) Int. Cl. B32B 27/00

(52) U.S. Cl. 428/220

(57) ABSTRACT

A laminate film having a base layer which contains a thermoplastic resin, and a surface layer which is laminated on at least one surface of the base layer and contains a polycarbonate resin, in which a total thickness of the laminate film is from 20 to 500 μm and a thickness of the base layer constitutes at least 50% of the total thickness of the laminate film.

### FIELD OF THE INVENTION

The present invention relates to a laminate film. The present invention also relates to a decorative film or sheet and a decorative article produced by using the laminate film.

### DESCRIPTION OF THE BACKGROUND ART

Thermoplastic resin (or plastic) films are used in various applications by making use of their respective characteristics. For example, acrylic films are preferably used as films for decorating the surfaces of exterior components of household electric appliances or interior components of automobiles, namely as decorative films by making use of their excellent transparency and weather resistance. Polypropylene films are preferably used as films for wrapping products by making use of their excellent tensile strength and rigidity. Polyester films are preferably used as shrinkable films for labels on PET bottles by making use of their excellent heat resistance and thin film formability.

### SUMMARY OF THE INVENTION

Thermoplastic resin films such as those described above are sometimes touched by human bodies in their usage environments. When the frequency and degree of the touches are high, sweat marks may remain or cracks may be formed due to the action of lactic acid contained in sweat.

One object of the present invention is to provide a thermoplastic resin film having excellent resistance to lactic acid.

Another object of the present invention is to provide a decorative film or sheet and also a decorative article, which have excellent resistance to lactic acid by using such a thermoplastic resin film.

The present invention provides a laminate film comprising a base layer which comprises a thermoplastic resin, and a surface layer which is laminated on at least one surface of the base layer and comprises a polycarbonate resin, wherein a total thickness of the laminate film is from 20 to 500 μm and a thickness of the base layer constitutes at least 50% of the total thickness of the laminate film.

The present invention also provides the laminate film, wherein the surface layer further comprises a methyl methacrylate-styrene copolymer resin, that is, a laminate film comprising a base layer which comprises a thermoplastic resin and a surface layer which is laminated on at least one surface of the base layer, and comprises a methyl methacrylate-styrene copolymer resin and a polycarbonate resin.

The laminate film of the present invention can be used as a decorative film, for example, when the surface layer is laminated on one surface of the base layer and a printed layer is formed on a surface opposite to the surface of the laminate film on which the surface layer is laminated. The decorative film can also be fabricated into a decorative sheet by laminating a thermoplastic resin sheet onto the surface having the printed layer. In addition, a decorative article having excellent resistance to lactic acid can be obtained by laminating a molded article of a thermoplastic resin on the surface of the decorative film having a print thereon or on the surface of the decorative sheet on which the thermoplastic resin sheet is laminated.

Since the laminate film of the present invention has excellent resistance to lactic acid, a decorative film or sheet and a decorative article having excellent resistance to lactic acid can be obtained by using the laminate film.

### DETAILED DESCRIPTION OF THE INVENTION

The laminate film of the present invention has a base layer which comprises a thermoplastic resin, and a surface layer which comprises a polycarbonate resin laminated on at least one surface of the base layer.

Examples of the thermoplastic resin which constitutes the base layer include a methacrylic resin, a polyester resin, a poly(cycloolefin) resin, an acrylonitrile-butadiene-styrene copolymer resin (ABS resin), a polvinylidene fluoride resin (PVDF resin), etc. The kind of the thermoplastic resin may be appropriately selected depending on the applications of a final product to be produced, such as a laminate film. For example, for a surface decoration application, a thermoplastic resin having high transparency, especially a methacrylic resin, is preferably used.

The methacrylic resin is a polymer comprising a methacrylic acid ester as a main component and may be either a homopolymer of a methacrylic acid ester or a copolymer of 50% by weight or more of a methacrylic acid ester and 50% by weight or less of a monomer other than methacrylic acid esters. Here, an alkyl ester of methacrylic acid is usually used as the methacrylic acid ester.

A preferable monomeric composition of the methacrylic resin contains 50 to 100% by weight of an alkyl methacrylate, 0 to 50% by weight of an alkyl acrylate, and 0 to 49% by weight of a monomer other than alkyl methacrylates and alkyl acrylates, and more preferably 50 to 99.9% by weight of an alkyl methacrylate, 0.1 to 50% by weight of an alkyl acrylate, and 0 to 49% by weight of a monomer other than alkyl methacrylates and alkyl acrylates, on the basis of all the monomers.

The alkyl group of an alkyl methacrylate usually has 1 to 8 carbon atoms, preferably 1 to 4 carbon atoms. Examples of such alkyl methacrylates include methyl methacrylate, ethyl methacrylate, butyl methacrylate, 2-ethylhexyl methacrylate, etc. In particular, methyl methacrylate is preferred.

The alkyl group of an alkyl acrylate usually has 1 to 8 carbon atoms, preferably 1 to 4 carbon atoms. Examples of such alkyl acrylates include methyl acrylate, ethyl acrylate, butyl acrylate, 2-ethylhexyl acrylate, etc.

The monomer other than alkyl methacrylates and alkyl acrylates may be either a monofunctional monomer, that is, a compound having one polymerizable carbon-carbon double bond in the molecule, or a polyfunctional monomer, that is, a compound having at least two polymerizable carbon-carbon double bonds in the molecule. However, a monofunctional monomer is preferably used. Examples of such monofunctional monomers include aromatic alkenyl compounds such as styrene, α-methylstyrene and vinyltoluene, and alkenyl cyanide compounds such as acrylonitrile and methacrylonitrile. Examples of such a polyfunctional monomer include polyunsaturated carboxylic acid esters of polyhydric alcohols such as ethylene glycol dimethacrylate, butanediol dimethacrylate and trimethylolpropane triacrylate, alkenyl esters of unsaturated carboxylic acids such as allyl acrylate, allyl methacrylate and allyl cinnamate, polyalkenyl esters of polybasic acids such as diallyl phthalate, diallyl maleate, triallyl cyanurate and triallyl isocyanurate, and aromatic polyalkenyl compounds such as divinylbenzene.

With regard to the alkyl methacrylates, the alkyl acrylates and the monomers other than alkyl methacrylates and alkyl acrylates, in each case, two or more species thereof may be used in combination, if necessary.

In view of the heat resistance of the base layer, preferably, the methacrylic resin has a glass transition temperature of 40° C. or higher, and more preferably of 60° C. or higher. The glass transition temperature can be appropriately set by selecting the kinds of monomers and their ratio.

The methacrylic resin can be prepared by polymerizing a monomer or monomers by a polymerization method such as suspension polymerization, emulsion polymerization and bulk polymerization. In such a case, a chain transfer agent is preferably used during the polymerization in order to obtain an appropriate glass transition temperature or to obtain a viscosity advantageous for the formation of the laminate film. The amount of the chain transfer agent may be determined appropriately depending on the kinds of monomers and their ratio.

From the viewpoint of the flexibility of a laminate film to be obtained, it is preferable to blend rubber particles to a thermoplastic resin, especially a methacrylic resin, and form a base layer from the resulting composition. For example, acrylic rubber particles, butadiene based rubber particles, or styrene-butadiene based rubber particles can be used as the rubber particles. Particularly, acrylic rubber particles are preferably used from the viewpoint of weather resistance.

Acrylic rubber particles are particles containing, as a rubber component, an elastomeric polymer comprising an acrylic acid ester. The acrylic rubber particles may be either particles having a single layer structure consisting of the elastomeric polymer or particles having a multilayer structure having the layer of such an elastomeric polymer. From the viewpoint of the surface hardness of the base layer, the acrylic rubber particles are those having a multilayer structure. The elastomeric polymer may be either a homopolymer of an acrylic acid ester or a copolymer of 50% by weight or more of an acrylic acid ester and 50% or less of a monomer other than acrylic acid esters. An alkyl ester of acrylic acid is usually used as the acrylic acid ester.

A preferable monomeric composition of the elastomeric polymer comprising an acrylic acid ester as a main component contains 50 to 99.9% by weight of an alkyl acrylate, 0 to 49.9% by weight of a monofunctional monomer other than alkyl acrylates, and 0.1 to 10% by weight of a polyfunctional monomer, on the basis of all the monomers.

Examples of the alkyl acrylate are the same as those of the alkyl acrylate exemplified above as the monomer component of the methacrylic resin. The number of carbon atoms in the alkyl group is usually from 1 to 8, preferably from 4 to 8.

The monofunctional monomer other than alkyl acrylates may be a monofunctional monomer including an alkyl methacrylate. Examples thereof are the same as the examples of the alkyl methacrylate and the examples of the monofunctional monomer other than alkyl methacrylates and alkyl acrylates exemplified above as the monomer component of the methacrylic resin.

Examples of the polyfunctional monomer are the same as the examples of the polyfunctional monomer exemplified above as the monomer component of the methacrylic resin. In particular, an alkenyl ester of an unsaturated carboxylic acid or a polyalkenyl ester of a polybasic acid is preferably used.

With regard to the alkyl acrylates, the monofunctional monomers other than alkyl acrylates and the polyfunctional monomers other than alkyl acrylates, in each case, two or more species thereof may be used in combination, if necessary.

When the particles having a multilayer structure are used as acrylic rubber particles, preferable examples thereof include particles having a layer of an elastomeric polymer comprising an acrylic acid ester and a layer of a polymer comprising a methacrylic acid ester formed around the former layer, that is particles having a structure comprising at least two layers including an inner layer of an elastomeric polymer comprising an acrylic acid ester and an outer layer of a polymer comprising a methacrylic acid ester. Here, an alkyl methacrylate is usually used as the methacrylic acid ester, which is the monomer component of the polymer of the outer layer. The amount of the polymer of the outer layer is usually from 10 to 400 parts by weight, preferably from 20 to 200 parts by weight, per 100 parts by weight of the elastomeric polymer of the inner layer. Adjusting the amount of the polymer of the outer layer to 10 parts by weight or more per 100 parts by weight of the elastomeric polymer of the inner layer makes the elastomeric polymer less prone to agglomerate and improves the transparency of the base layer.

A preferable monomeric composition of the polymer of the outer layer contains 50 to 100% by weight of an alkyl methacrylate, 0 to 50% by weight of an alkyl acrylate, and 0 to 49% by weight of a monomer other than alkyl methacrylates and alkyl acrylates, on the basis of all the monomers.

Examples of the alkyl methacrylate are the same as those of the alkyl methacrylate exemplified above as the monomer component of a methacrylic resin. The number of carbon atoms in the alkyl group is usually from 1 to 8, preferably from 4 to 8. In particular, methyl methacrylate is preferably used.

Examples of the alkyl acrylate are the same as those of the alkyl acrylate exemplified above as the monomer component of a methacrylic resin. The number of carbon atoms in the alkyl group is usually from 1 to 8, preferably from 1 to 4.

The monomer other than alkyl methacrylates and alkyl acrylates may be either a monofunctional monomer or a polyfunctional monomer. A monofunctional monomer is preferably used. Examples of the monofunctional monomer are the same as those of the monofunctional monomer other than the alkyl methacrylate and the alkyl acrylate exemplified above as the monomer component of the methacrylic resin. Examples of the polyfunctional monomer are the same as those of the polyfunctional monomer exemplified above as the monomer component of the methacrylic resin.

With regard to the alkyl methacrylates, the alkyl acrylates and the monomers other than alkyl methacrylates and alkyl acrylates, in each case two or more species thereof may be used in combination, if necessary.

Preferable examples of the acrylic rubber particles having a multilayer structure include particles further having a layer of a polymer comprising a methacrylic acid ester formed inside the layer of an elastomeric polymer comprising an acrylic acid ester, which is the inner layer of the two-layer structure, that is, particles having a structure comprising at least three layers including an inner layer of a polymer comprising an acrylic acid ester, an intermediate layer of an elastomeric polymer comprising the acrylic acid ester, and an outer layer of a polymer comprising a methacrylic acid ester. Here, an alkyl methacrylate is usually used as the methacrylic acid ester, which is the monomer component of the polymer of the inner layer. The polymer of the inner layer is preferably formed in an amount of from 10 to 400 parts by weight, preferably from 20 to 200 parts by weight based on 100 parts by weight of the elastomeric polymer of the intermediate layer.

A preferable monomeric composition of the polymer of the inner layer contains 70 to 100% by weight of an alkyl methacrylate and 0 to 30% by weight of a monomer other than alkyl methacrylates, on the basis of all the monomers.

Examples of the alkyl methacrylate are the same as those of the alkyl methacrylate exemplified above as the monomer component of the methacrylic resin. The number of carbon atoms in the alkyl group is usually from 1 to 8, preferably from 1 to 4. In particular, methyl methacrylate is preferably used.

The monomer other than alkyl methacrylates may be either a monofunctional monomer including alkyl acrylates or a polyfunctional monomer. Examples of the monofunctional monomer are the same as those of the alkyl acrylate and those of the monofunctional monomer other than alkyl methacrylates and alkyl acrylates exemplified above as the monomer component of the methacrylic resin. Examples of the polyfunctional monomer are the same as those of the polyfunctional monomer exemplified above as the monomer component of the methacrylic acid resin.

With regard to the alkyl methacrylates and the monomers other than alkyl methacrylates, in each case, two or more species thereof may be used in combination, if necessary.

The acrylic rubber particles may be prepared by polymerizing the monomer components of the elastomeric polymer comprising an acrylic acid ester by emulsion polymerization or the like through a reaction of at least one step. When the outer layer of the polymer comprising a methacrylic acid ester is formed around the layer of the elastomeric polymer as described previously, the outer layer may be formed by polymerizing the monomer components of the polymer of the outer layer in the presence of the elastomeric polymer by emulsion polymerization or the like through a reaction of at least one step to graft the monomer components to the elastomeric polymer. When the innermost layer of the polymer comprising a methacrylic acid ester is additionally formed inside the layer of the elastomeric polymer as described previously, the innermost layer may be formed by firstly polymerizing the monomer components of the polymer of the innermost layer by emulsion polymerization or the like through a reaction of at least one step, subsequently polymerizing the monomer components of the elastomeric polymer in the presence of the resulting polymer by emulsion polymerization or the like through a reaction of at least one step to graft the monomer components to the polymer of the innermost layer, and further polymerizing the monomer components of the polymer of the outer layer in the presence of the resulting elastomeric polymer by emulsion polymerization or the like through a reaction of at least one step to graft the monomer components to the elastomeric polymer. When the polymerization of each layer is performed in two steps or more, not all of the monomeric compositions of the respective steps but only the overall monomeric composition is required to be within the specified range.

With regard to the particle diameter of acrylic rubber particles, the average particle diameter of the layer of the elastomeric polymer comprising the acrylic acid ester in the rubber particles is preferably from 0.05 to 0.4 μm, more preferably from 0.1 to 0.3 μm, and even more preferably from 0.14 to 0.25 μm. When the average particle diameter is too large, the base layer becomes less transparent. When the average particle diameter is too small, the base layer becomes more liable to be scratched due to the decrease of its surface hardness or the base layer becomes more liable to be broken due to the decrease of its flexibility. In order to control the whitening of a film caused by bending the film, it is preferable that the particle diameter is smaller and also that the particles have the two-layer structure, which has no innermost hard layer.

The average particle diameter can be determined by the following method: The acrylic rubber particles and the methacrylic resin are mixed and formed into a film, the layers of the elastomeric polymer in a cross section of the film are stained with ruthenium oxide and observed by an electron microscope, and the average particle diameter is calculated from the diameters of the stained portions. When the acrylic rubber particles are mixed with the methacrylic resin and the cross section of the resulting mixture is stained with ruthenium oxide, the methacrylic resin, which is the mother phase, is not stained and, if the layers of the polymer comprising a methacrylic acid ester are present outside the layers of the elastomeric polymer, the polymer of the outer layers is not stained either and only the layers of the elastomeric polymer are stained. The particle diameter can be determined based on the diameter of a portion which is stained with ruthenium oxide and which can be observed substantially in a circular form by an electron microscope. When the layer of the polymer comprising a methacrylic acid ester is present inside the layer of the elastomeric polymer, the polymer of the innermost layer is not stained either and thus the cross section is observed as if a two-layer structure, in which the outer layer of the elastomeric polymer has been stained, is present. In such a case, the diameter of the outer periphery of the two-layer structure, namely, the outer diameter of the layer of the elastomeric polymer is regarded as a particle diameter.

The methacrylic resin and the acrylic rubber particles are used in an amount of from 20 to 95 parts by weight and an amount of from 5 to 80 parts by weight, respectively, based on 100 parts by weight of the total amount of them. When the amount of the methacrylic resin is too small and thus the amount of the acrylic rubber particles is too large, the surface hardness of the film decreases, so that the film is easily scratched and in addition, the appearance of an article deteriorates after the transfer of a shape. On the other hand, when the amount of the methacrylic resin is too large and thus the amount of the acrylic rubber particles is too small, the flexibility of the film decreases, so that the film is easily broken.

The amount of the elastomeric polymer comprising the acrylic acid ester in the acrylic rubber particles is preferably from 5 to 35 parts by weight, more preferably from 10 to 25 parts by weight, based on 100 parts by weight of the methacrylic resin and the acrylic rubber particles in total. When the amount of the elastomeric copolymer per 100 parts by weight of the methacrylic resin and the acrylic rubber particles in total is 5 parts by weight or more, the film formability can be improved without making the base layer fragile. On the other hand, when the amount of the elastomeric copolymer per 100 parts by weight of the methacrylic resin and the acrylic rubber particles in total is 35 parts by weight or less, the transparency or surface hardness of the base layer can be increased.

In addition to the rubber particles, other components such as UV absorbers, organic dyes, inorganic dyes, pigments, antioxidants, antistatic agents and surfactants may be added to the thermoplastic resin constituting the base layer if necessary.

The polycarbonate resin which constitutes the surface layer may generally be obtained by the condensation reaction of a dihydroxy compound with a carbonylation agent such as phosgene. In particular, an amorphous aromatic polycarbonate prepared by using bisphenol A as a dihydroxyl compound is preferred.

The weight average molecular weight of the polycarbonate resin is preferably from 30,000 to 50,000, and more preferably from 35,000 to 45,000. When the polycarbonate resin has a very small molecular weight or when it has a very large molecular weight, molding defects such as flow marks may easily be formed. If the polycarbonate resin has a very large molecular weight, a temperature difference between the thermoplastic resin and the polycarbonate resin increases during the production of a laminate film by co-extrusion, which will be explained below, and as a result, the laminate film tends to easily curl.

The melt volume flow rate (MVR) of the polycarbonate resin is preferably from 3 to 40 cm³/10 min., and more preferably from 5 to 15 cm³/10 min. as measured at a temperature of 300° C. and a load of 1.2 kg. When the polycarbonate has a very small MVR or when it has a very large MVR, it is difficult to process a film comprising such polycarbonate during the production of a laminate film by co-extrusion, which will be described below. The MVR is measured in accordance with ISO 1133.

Although the surface layer may consist of the polycarbonate resin, it may additionally contain other resin, as long as the objects of the present invention are achieved. For example, from the viewpoint of moldability, preferably, the surface layer in the laminate film of the present invention further contains a methyl methacrylate-styrene copolymer resin. In a preferred embodiment of the laminate film of the present invention, a surface layer comprising a methyl methacrylate-styrene copolymer resin and a polycarbonate resin is laminated on at least one of the surfaces of the base layer made of a thermoplastic resin.

Examples of resins which are used as the methyl methacrylate-styrene copolymer resin include those comprising, based on the amount of all repeating units of monomers, from 1 to 30% by weight of repeating units of methyl methacrylate and from 70 to 99% by weight of repeating units of styrene, preferably include those comprising from 2 to 15% by weight of repeating units of methyl methacrylate and from 85 to 98% by weight of repeating units of styrene. When the amount of the repeating units of methyl methacrylate is too small, the film as a whole will be more easily broken because of the decrease of breaking strength of the surface layer itself, the surface hardness will become lower and mixing properties with a polycarbonate resin and especially optical properties will deteriorate. When the amount of the repeating units of methyl methacrylate is too large, mixing properties with a polycarbonate resin and especially optical properties will deteriorate. The methyl methacrylate-styrene copolymer resin may optionally comprise repeating units of a monomer other than the repeating units of methyl methacrylate and the repeating units of styrene. Examples of such repeating units of monomers include repeating units of divinylbenzene and repeating units of alkyl acrylate. The amount of the optional repeating units of such a monomer is usually not more than 10% by weight based on all the repeating units.

When the surface layer comprises a resin mixture of the methyl methacrylate-styrene copolymer resin and the polycarbonate resin, the resins are used preferably after being melt-kneaded. In such a case, the weight ratio of the methyl methacrylate-styrene copolymer resin to the polycarbonate resin is usually from 1/20 to 20/1, preferably from 1/10 to 10/1, and more preferably from 1/5 to 5/1. When the weight ratio is too small, in other words, when the resin mixture contains a very small amount of the methyl methacrylate-styrene copolymer resin and a very large amount of the polycarbonate resin, high heat resistance of the polycarbonate resin makes the molding cycle longer in production of a laminate film by thermoforming such as vacuum forming or pressure forming, resulting in the decrease of production efficiency. When the weight ratio is too large, in other words, when the resin mixture contains a very large amount of the methyl methacrylate-styrene copolymer resin and there is a very small amount of the polycarbonate resin, the breaking strength of the surface layer decreases, which results in the decrease of the strength of the film as a whole, and the worsening of the adherability of the surface layer to the methacrylic resin which is preferably used as the base layer.

The difference (Δη=η1−η2) between the refractive index (η1) of the methyl methacrylate-styrene copolymer resin and the refractive index (η2) of the polycarbonate resin is preferably from −0.05 to +0.05. When Δη is too small or too large, the resin mixture has a high haze, resulting in the decrease of the transparency of the film itself. Δη may be adjusted easily by the adjustment of η1. In particular, it can be adjusted appropriately by adjusting the content of repeating units of methyl methacrylate in the methyl methacrylate-styrene copolymer resin.

To the resin which constitutes the surface layer, other components such as UV absorbers, organic dyes, inorganic dyes, pigments, antioxidants, antistatic agents and surfactants may optionally be added.

An effective way to render the surface layer matte is the addition of organic particles and/or inorganic particles to the resin constituting the surface layer to form a matte surface layer. For example, crosslinked acrylic polymer particles or crosslinked styrene polymer particles are used as the organic particles. Examples of inorganic particles include silica and alumina. The amount of such particles used is appropriately adjusted according to the desired surface gloss and it is usually about 0.1 to 50% by weight based on all the materials constituting the surface layer.

When a laminate film is produced from the thermoplastic resin as a material constituting a base layer and the resin containing the polycarbonate resin as a material constituting the surface layer, which are both described above, the laminate film of the present invention is obtained which comprises the base layer comprising the thermoplastic resin and the surface layer comprising the resin containing the polycarbonate resin that is laminated on at least one surface of the base layer. The method of producing the laminate film may be selected appropriately. Examples of such a method include a coextrusion method in which respective resins are molten in extruders and then laminated each other using a feed block method or a multi-manifold method; a coating method in which a film is formed from a thermoplastic resin by an extrusion method or the like and then a polycarbonate resin is coated on the surface of the film optionally after the polycarbonate resin is dissolved in a solvent; and a lamination method in which two films are formed from respective resins by an extrusion method or the like and the films are laminated using heat or an adhesive. Among them, the coextrusion method and the coating method are preferable and the coextrusion method is more preferable. The lamination method is less preferable because it is difficult to form a thin film of the polycarbonate resin by this method and also because the quality of the laminate film may be deteriorated during the lamination step by foreign matters and it is disadvantageous from the viewpoint of the costs.

The thickness of the laminate film thus obtained is usually from 20 to 500 μm, preferably from 50 to 250 μm, more preferably from 60 to 200 μm, and even more preferably from 75 to 150 μm. An excessively thick laminate film requires a longer time when it is molded in the form of an automotive interior material, for example. In addition, it has only a small effect on the improvement of physical properties or designing properties and it leads to a high cost. On the other hand, an excessively thin laminate film is difficult to be produced by extrusion because of mechanical restrictions. In addition, it has a reduced rupture strength, resulting in a high probability of troubles during the production. Moreover, the handling of such a thin film is difficult. The thickness of the laminate film can be adjusted in coextrusion by, for example, adjusting the film-forming rate, the clearance of the discharge slot of a T die, the gap between rolls, and the like.

The base layer comprising the thermoplastic resin has a thickness of at least 0.5 times the overall thickness of the laminate film. When the base layer is thin, in other words, when the surface layer is thick, it is necessary to increase a heating temperature or to lengthen a heating time during the production of the laminate film by thermoforming such as vacuum forming or pressure forming, because of the high heat resistance of the polycarbonate resin. These necessities result in a prolonged cycle time, which decreases the production efficiency. Moreover, the handling property of such a film is poor and the cost of the film itself will increase.

The thickness of the surface layer is preferably from 1 to 100 μm. When the surface layer is too thin, the resistance to lactic acid is insufficient. When the surface layer is too thick, it is necessary to increase a heating temperature or to lengthen a heating time during the production of the laminate film by thermoforming such as vacuum forming or pressure forming, because of the high heat resistance of a polycarbonate resin. These necessities result in a prolonged cycle time, which decreases the production efficiency. Moreover, the handling property of such a film is poor and the cost of the film itself will increase. The thickness of the surface layer is preferably at least 3 μm, and more preferably at least 10 μm, and it is preferably not more than 50 μm. When the surface layers are formed on the both sides of the base layer, each surface layer has a thickness in the above range. When the thickness of the surface layer is 10 μm or more, a coextrusion method is advantageously employed as a method of producing the laminate film. When the thickness of the surface layer is from about 1 to about 10 μm, a coating method is advantageously employed as a method of producing a laminate film. The laminate film as a whole preferably has a haze of 2% or less and also preferably has a total light transmittance of 90% or more if the film is not a matte film.

The laminate film of the present invention is preferably used as a material for forming a decorative film. In this case, the laminate film in which the surface layer is laminated on one side of the base layer is preferably used. It is advantageous that a printed layer is formed as a decoration means on the side opposite to the side on which the surface layer is laminated. Examples of the method therefor include a method in which the surface of the base layer is directly printed by continuous gravure printing or silk printing, and a method in which an additional resin film which has been printed is laminated.

The decorative film can also be fabricated into a decorative sheet by laminating a thermoplastic resin sheet as a lining onto the surface on which the printed layer is formed. Examples of the resin which constitutes the thermoplastic resin sheet include an ABS resin, a methacrylic resin, a polyvinyl chloride resin, a polyurethane resin, a polyester resin and a polyolefin resin. The range of the thickness of the thermoplastic resin sheet includes that of a so-called film, and it is usually from about 0.2 to about 2 mm.

A decorative article having excellent resistance to lactic acid can be obtained by laminating the thus-obtained decorative film or decorative sheet to a molded article of a thermoplastic resin with the surface layer comprising the polycarbonate resin facing outwardly, that is, in the case of a decorative film, by laminating a molded article of a thermoplastic resin to the surface of the film on which a printed layer is formed, or in the case of a decorative sheet, by laminating a molded article of a thermoplastic resin to the surface of the sheet on which the thermoplastic resin sheet is laminated. Examples of the resin which constitutes the molded article of the thermoplastic resin include an ABS resin, a methacrylic resin, a polyvinyl chloride resin, a polyurethane resin, a polyester resin and a polyolefin resin.

Its a method for producing a decorative article, a simultaneous injection molding-lamination method is advantageously used. The simultaneous injection molding-lamination method can be performed by, for example, a method comprising inserting the aforementioned film or sheet into an injection mold without preliminarily forming it, and then injecting a molten resin in the mold to simultaneously form an injection molded article and laminate the film or sheet onto the article, which method is sometimes called a simultaneous injection molding-lamination method in a narrow sense; a method comprising inserting the aforementioned film or sheet into an injection mold after preliminarily forming it by vacuum forming, pressure forming, or the like, and then injecting a molten resin in the mold to simultaneously form an injection molded article and laminate the film or sheet onto the article, which method is sometimes called an insert molding method; or a method comprising preliminarily forming the aforementioned film or sheet by vacuum forming, pressure forming, or the like in an injection mold, and then injecting a molten resin in the mold to simultaneously form an injection molded article and laminate the film or sheet onto the article, which method is sometimes called an in-mold molding method. The simultaneous injection molding-lamination method is described in further detail in, for example, JP-B 63-6339, JP-B 4-9647 and JP-A 7-9484.

### EXAMPLES

Examples of the present invention are described below, but they do not limit the present invention. In the Examples, all % and parts indicating contents or used amounts are by weight unless otherwise indicated.

As a methacrylic resin, pellets of a thermoplastic polymer having a glass transition temperature of 104° C. obtained by bulk polymerization of a monomer mixture consisting of 97.8% of methyl methacrylate and 2.2% of methyl acrylate were used. The glass transition temperature is an extrapolated onset temperature of glass transition by differential scanning calorimetry at a heating rate of 10° C./min. in accordance with JIS K7121: 1987.

As acrylic rubber particles (A), rubber particles were used, which had a spherical three-layer structure produced by emulsion polymerization, wherein the weight ratio of innermost layer/intermediate layer/outermost layer was 35/45/20, the average particle diameter of the elastomeric polymer of the intermediate layer was 0.22 μm, the innermost layer consisted of a hard polymer obtained by the polymerization of a monomer mixture of 93.8% of methyl methacrylate, 6% of methyl acrylate and 0.2% of allyl methacrylate, the intermediate layer consisted of an elastomeric polymer obtained by the polymerization of a monomer mixture of 81% of butyl acrylate, 17% of styrene and 2% of allyl methacrylate, and the outermost layer consisted of a hard polymer obtained by the polymerization of a monomer mixture of 94% of methyl methacrylate and 6% of methyl acrylate.

As acrylic rubber particles (B), rubber particles were used, which had a spherical three-layer structure having substantially the same composition as that of the acrylic rubber particles (A), except that the average particle diameter of the elastomeric polymer of the intermediate layer was made 0.14 μm by changing the polymerization conditions.

As acrylic rubber particles (C), rubber particles were used, which had a spherical two-layer structure produced by emulsion polymerization, wherein the inner layer consisted of an elastomeric polymer obtained by the polymerization of a monomer mixture of 81% of butyl acrylate, 17% of styrene and 2% of allyl methacrylate, the outer layer consisted of a hard polymer obtained by the polymerization of a monomer mixture of 94% of methyl methacrylate and 6% of methyl acrylate, and the average particle diameter of the elastomeric polymer of the intermediate layer was 0.075 μm.

The average particle diameter of the intermediate elastomeric polymer layer in each of the acrylic rubber particles (A), (B) and (C) was measured by the following method.

### [Measurement of Average Particle Diameter of Elastomeric Polymer Layers]

The acrylic rubber particles were mixed with a methacrylic resin, and a film was formed from the resulting mixture. The film was cut into an appropriate size. The resulting sample piece was immersed in a 0.5% aqueous solution of ruthenium tetraoxide at a room temperature for 15 hours. The layers of the elastomeric copolymer in the rubber particles were thereby stained. The sample piece was sliced into a thickness of about 80 nm with a microtome, and then photographed using a transmission electron microscope. In this photograph, 100 stained layers of the elastomeric copolymer were selected at random. The particle diameters of the individual layers were measured and then averaged to obtain an average particle diameter.

A resin containing 5% by weight of repeating units of methyl methacrylate and 95% by weight of repeating units of styrene was used as methyl methacrylate-styrene copolymer resin (a). This resin is hereinafter referred to as MS resin (a).

A resin containing 3% by weight of repeating units of methyl methacrylate and 97% by weight of repeating units of styrene was used as methyl methacrylate-styrene copolymer resin (b). This resin is hereinafter referred to as MS resin (b).

A resin containing 60% by weight of repeating units of methyl methacrylate and 40% by weight of repeating units of styrene was used as methyl methacrylate-styrene copolymer resin (c). This resin is hereinafter referred to as MS resin (c).

Calibre 301-10 (produced by Sumitomo Dow Limited) was used as a polycarbonate resin (a). The polycarbonate resin (a) has a weight average molecular weight of 43,000, and a melt volume flow rate of 10 cm³/10 min. when measured at 300° C. under a load of 1.2 kg. This polycarbonate resin is sometimes abbreviated as a PC resin in Examples 11 to 20 and Table 2 given below.

Calibre 301-15 (produced by Sumitomo Dow Limited) was used as a polycarbonate resin (b). The polycarbonate resin (b) has a weight average molecular weight of 38,000, and a melt volume flow rate of 15 cm³/10 min. when measured at 300° C. under a load of 1.2 kg.

Calibre 1080DVD produced by Sumitomo Dow Limited was used as a polycarbonate resin (c). The polycarbonate resin (c) has a weight average molecular weight of 10,000, and a melt volume flow rate of 76 cm³/10 min. when measured at 300° C. under a load of 1.2 kg.

### Examples 1-10

In each example, the pellets of a methacrylic resin composition were produced by mixing the methacrylic resin pellets described above and the acrylic rubber particles (A) or (B) in a ratio shown in Table 1 in a super mixer, and melt-kneading and extruding the mixture with a twin screw extruder. The pellets of a polycarbonate resin or a composition thereof were produced by melt-kneading and extruding the aforementioned polycarbonate resin (a), (b) or (c) only with a twin screw extruder (Examples 1 to 6 and Comparative Examples 1 and 2), or by mixing the polycarbonate resin with a matting agent (organic particles; XX-24K produced by Sekisui Plastics Co., Ltd.) in a ratio shown in Table 1 in a super mixer and melt-kneading and extruding with a twin screw extruder (Examples 7 and 8). Subsequently, the pellets of the methacrylic resin composition and the pellets of the polycarbonate resin or a composition thereof were melted in a single screw extruder having a diameter of 65 mm (manufactured by Toshiba Machine Co., Ltd.) and in a single screw extruder having a diameter of 45 mm (manufactured by Toshiba Machine Co., Ltd.), respectively. Then, they were melt-laminated together by a feed block method and extruded through a T-die kept at a temperature of 275° C. The resulting film was shaped by nipping it between a pair of metal rolls having smooth surfaces. Thus, a laminate film having a two-layer structure shown in Table 1 was produced and was subjected to the evaluations provided below. The results are shown in Table 1.

### Examples 11-20

In each example, the pellets of a methacrylic resin composition were produced by mixing the methacrylic resin pellets described above and the acrylic rubber particles (A), (B) or (C) in a ratio shown in Table 2 in a super mixer, and melt-kneading and extruding the mixture with a twin screw extruder. In each example, the pellets of a resin mixture were produced by mixing the MS resin (a), (b) or (c) and the PC resin in a ratio shown in Table 2 in a super mixer, and melt-kneading and extruding the mixture with a twin screw extruder. Subsequently, the pellets of the methacrylic resin composition and the pellets of the resin mixture were melted in a single screw extruder having a diameter of 65 mm (manufactured by Toshiba Machine Co., Ltd.) and in a single screw extruder having a diameter of 45 mm (manufactured by Toshiba Machine Co., Ltd.), respectively. Then, they were melt-laminated together by a feed block method and extruded through a T-die kept at a temperature of 275° C. The resulting film was shaped by nipping it between a pair of metal rolls having smooth surfaces. Thus, a laminate film having a two-layer structure shown in Table 2 was produced and was subjected to the evaluations provided below. The results are shown in Table 2.

### [Resistance to Lactic Acid]

A 10% aqueous lactic acid solution was prepared. One drop of the aqueous lactic acid solution was dropped onto the surface of a film (on the surface layer) and was kept standing in a oven kept at 40° C. for 24 hours. Then, the state of the film surface was visually checked. A film in which a notable mark of the droplet was found, or the film surface was dissolved, or a crack was formed in the film is ranked “C”. A film in which a slight mark of the droplet was found is ranked “B”. A film in which no change was found is ranked “A”.

### [Moldability]

In a vacuum molding machine, a heating time required to mold a film completely into conformity with a box-shaped mold and the surface temperature of the film in the heating were measured. The shorter the heating time is, or the lower the film surface temperature in the heating is, the better the molding cycle characteristics is.

### [Optical Property]

By the method provided in JIS K7136, a total light transmittance (Tt) and a haze (Haze) were measured. They are shown together with the difference (Δη=η1−η2) between the refractive index (η1) of the MS resin and the refractive index (η2) of the PC resin.

### [Appearance]

A film in which many flow marks were formed during the film production is ranked “C”. A film in which several flow marks were formed is ranked “B”. A film in which no occurrence of flow marks was confirmed is ranked “A”.

### Comparative Example 1

The pellets of a methacrylic resin composition were produced by mixing the methacrylic resin pellets described above and the acrylic rubber particles (A) in a ratio shown in Table 1 in a super mixer, and melt-kneading and extruding the mixture with a twin screw extruder. Subsequently, the pellets of the methacrylic resin composition were melted in a single screw extruder having a diameter of 65 mm (manufactured by Toshiba Machine Co., Ltd.). Then, the melt was extruded through a T-die kept at a temperature of 275° C. The resulting film was shaped by nipping it between a pair of metal rolls having smooth surfaces. Thus, a monolayer acrylic film having a thickness shown in Table 1 was produced and was subjected to the same evaluations as those described above. The results are shown in Tables 1 and 2.

### Example 21

A laminate film having a thickness shown in Table 1 was produced by applying the solution of the polycarbonate resin (a) in dichloromethane to a monolayer acrylic film prepared in the same manner as in Comparative Example 3 and drying the film. This film was subjected to the same evaluations as those described above and the results are shown in Table 1.

### Comparative Example 2

The aforementioned polycarbonate resin (a) was melted in a single screw extruder having a diameter of 65 mm (manufactured by Toshiba Machine Co., Ltd.). Then, the melt was extruded through a T-die kept at a temperature of 275° C. The resulting film was shaped by nipping it between a pair of metal rolls having smooth surfaces. Thus, a monolayer polycarbonate resin film having a thickness shown in Table 1 was produced and was subjected to the same evaluations as those described above. The results are shown in Table 1.

TABLE 1

| | | Base layer | | | | Surface layer | | | | Evaluation | | | |
|---|---|---|---|---|---|---|---|---|---|---|---|---|---|
| | Overall | Methacrylic | Acrylic rubber | | | Polycarbonate | | Matting | | Resistance | | | |
| Example | Thickness | resin | particles | | Thickness | resin | | agent | Thickness | to lactic | Moldability | | |
| No. | (μm) | (parts) | (type) | (parts) | (μm) | (type) | (parts) | (parts) | (μm) | acid | (sec.) | (° C.) | Appearance |
| Example 1 | 125 | 70 | (A) | 30 | 105 | (a) | 100 | 0 | 20 | A | 20 | 190 | A |
| Example 2 | 125 | 70 | (A) | 30 | 105 | (b) | 100 | 0 | 20 | A | 22 | 200 | A |
| Example 3 | 125 | 70 | (A) | 30 | 105 | (c) | 100 | 0 | 20 | A | 20 | 200 | C |
| Example 4 | 125 | 30 | (B) | 70 | 105 | (a) | 100 | 0 | 20 | A | 20 | 190 | A |
| Example 5 | 125 | 30 | (B) | 70 | 105 | (b) | 100 | 0 | 20 | A | 20 | 190 | A |
| Example 6 | 300 | 70 | (A) | 30 | 250 | (a) | 100 | 0 | 50 | A | 30 | 210 | A |
| Example 7 | 125 | 70 | (A) | 30 | 105 | (a) | 80 | 20 | 20 | A | 20 | 190 | A |
| Example 8 | 75 | 70 | (A) | 30 | 55 | (a) | 80 | 20 | 20 | A | 18 | 180 | A |
| Example 9 | 125 | 70 | (A) | 30 | 45 | (a) | 100 | 0 | 80 | A | 24 | 230 | B |
| Example 10 | 300 | 70 | (A) | 30 | 200 | (a) | 100 | 0 | 100 | A | 34 | 230 | A |
| Example 21 | 128 | 70 | (A) | 30 | 125 | (a) | 100 | 0 | 3 | A | 17 | 170 | A |
| Comp. Ex. 1 | 125 | 70 | (A) | 30 | 125 | . . . | . . . | . . . | . . . | C | 16 | 160 | . . . |
| Comp. Ex. 2 | 125 | . . . | . . . | . . . | . . . | (a) | 100 | 0 | 125 | A | 24 | 240 | . . . |

TABLE 2

| | | Base layer | | | | Surface layer | | | | Evaluation | | | | |
|---|---|---|---|---|---|---|---|---|---|---|---|---|---|---|
| | Overall | Methacrylic | Acrylic rubber | | | | | PC | | Resistance | | | | Ap- |
| Example | Thickness | resin | particles | | Thickness | MS resin | | resin | Thickness | to lactic | | Tt | Haze | pear- |
| No. | (μm) | (parts) | (type) | (parts) | (μm) | (type) | (parts) | (parts) | (μm) | acid | Δη | (%) | (%) | ance |
| Example 11 | 125 | 70 | (A) | 30 | 105 | (a) | 20 | 80 | 20 | A | −0.001 | 90.8 | 1.0 | A |
| Example 12 | 125 | 70 | (A) | 30 | 105 | (b) | 40 | 60 | 20 | A | 0.001 | 91.2 | 1.0 | A |
| Example 13 | 125 | 30 | (B) | 70 | 105 | (a) | 20 | 80 | 20 | A | −0.001 | 91.0 | 0.9 | A |
| Example 14 | 125 | 30 | (C) | 70 | 105 | (a) | 20 | 80 | 20 | A | −0.001 | 91.2 | 0.9 | A |
| Example 15 | 125 | 70 | (A) | 30 | 105 | (a) | 60 | 40 | 40 | A | −0.001 | 90.9 | 1.1 | A |
| Example 16 | 125 | 70 | (A) | 30 | 105 | (a) | 80 | 20 | 20 | A | −0.001 | 91.4 | 0.8 | A |
| Example 17 | 125 | 70 | (A) | 30 | 105 | (b) | 80 | 20 | 20 | A | 0.001 | 90.9 | 1.0 | A |
| Example 18 | 125 | 30 | (C) | 70 | 105 | (b) | 80 | 20 | 80 | A | 0.001 | 91.1 | 0.9 | A |
| Example 19 | 300 | 70 | (A) | 30 | 250 | (a) | 20 | 80 | 50 | A | −0.001 | 91.2 | 0.9 | A |
| Example 20 | 125 | 70 | (A) | 30 | 105 | (c) | 20 | 80 | 20 | A | −0.053 | 82.3 | 15.3 | A |
| Comp. Ex. 1 | 125 | 70 | (A) | 30 | 125 | . . . | . . . | . . . | . . . | C | . . . | 92.1 | 0.6 | A |

1. A laminate film comprising a base layer which comprises a thermoplastic resin, and a surface layer which is laminated on at least one surface of said base layer and comprises a polycarbonate resin, wherein a total thickness of said laminate film is from 20 to 500 μm and a thickness of said base layer constitutes at least 50% of the total thickness of said laminate film.

2. The laminate film according to claim 1, wherein said surface layer has a thickness of 1 to 100 μm.

3. The laminate film according to claim 1, wherein said polycarbonate resin has a weight average molecular weight of 30,000 to 50,000.

4. The laminate film according to claim 1, wherein said polycarbonate resin has a melt volume flow rate of 3 to 40 cm³/10 min. when it is measured at 300° C. under a load of 1.2 kg.

5. The laminate film according to claim 1, wherein said surface layer further comprises a methyl methacrylate-styrene copolymer resin.

6. The laminate film according to claim 5, wherein said methyl methacrylate-styrene copolymer resin comprises 1 to 30% by weight of repeating units of methyl methacrylate and 70 to 99% by weight of repeating units of styrene.

7. The laminate film according to claim 5, wherein a weight ratio of the methyl methacrylate-styrene copolymer resin to the polycarbonate resin is from 1/20 to 20/1.

8. The laminate film according to claim 5, wherein a difference of a refractive index (η1) of the methyl methacrylate-styrene copolymer resin and a refractive index (η2) of the polycarbonate resin (η1−η2) is from −0.05 to +0.05.

9. The laminate film according to claim 1, wherein said thermoplastic resin in the base layer is a methacrylic resin.

10. The laminate film according to claim 9, wherein said methacrylic resin is a polymer prepared by polymerizing 50 to 100% by weight of an alkyl methacrylate and 0 to 50% by weight of an alkyl acrylate and 0 to 49% by weight of a monomer other than an alkyl methacrylate and an alkyl acrylate.

11. The laminate film according to claim 1, wherein said base layer further comprises rubber particles.

12. The laminate film according to claim 11, wherein said rubber particles are acrylic rubber particles.

13. The laminate film according to claim 12, wherein said acrylic rubber particles are particles comprising an elastomeric polymer prepared by polymerizing 50 to 99.9% by weight of an alkyl acrylate, 0 to 49.9% by weight of a monofunctional monomer other than an alkyl acrylate and 0.1 to 10% by weight of a polyfunctional monomer.

14. The laminate film according to claim 13, wherein said acrylic rubber particles are multilayer particles each having, around the outer surface of said elastomeric polymer particle, a polymer layer formed by polymerizing 50 to 100% by weight of an alkyl methacrylate, 0 to 50% by weight of an alkyl acrylate and 0 to 49% by weight of a monomer other than an alkyl methacrylate and an alkyl acrylate.

15. The laminate film according to claim 13, wherein said acrylic rubber particles are multilayer particles each having, inside a layer of said elastomeric polymer, a polymer layer formed by polymerizing 70 to 100% by weight of an alkyl methacrylate and 0 to 30% by weight of a monomer other than an alkyl methacrylate.

16. The laminate film according to claim 11, wherein said surface layer contains organic particles and/or inorganic particles.

17. The laminate film according to claim 1, which is produced by co-extruding said thermoplastic resin and said polycarbonate resin.

18. The laminate film according to claim 1, wherein said surface layer is a layer of the polycarbonate resin laminated on at least one surface of said base layer by coating.

19. The laminate film according to claim 1, wherein said surface layer is laminated only on one surface of said base layer.

20. A decorative film comprising a laminate film according to claim 19, and a printed layer formed on a surface opposite to said surface of said laminate film on which the surface layer is laminated.

21. A decorative sheet comprising a decorative film according to claim 20, and a thermoplastic resin sheet laminated on the surface of said decorative film having said printed layer.

22. A decorative article comprising a laminate film according to claim 20, and a molded article of a thermoplastic resin laminated on the surface of said decorative sheet having said printed layer.

23. A decorative article comprising a decorative sheet according to claim 21, and a molded article of a thermoplastic resin laminated on a surface of said thermoplastic resin sheet of said decorative sheet.
